(19) United States
(12) Patent Application Publication
(10) Pub. No.: US 2026/0167197 A1
(43) Pub. Date: Jun. 18, 2026

(54) VEHICLE CONTROL APPARATUS AND METHOD

(71) Applicants: HYUNDAI MOTOR COMPANY, Seoul (KR); KIA CORPORATION, Seoul (KR)

(72) Inventor: Han Shik Kim, Hwaseong-si (KR)

(73) Assignees: HYUNDAI MOTOR COMPANY, Seoul (KR); KIA CORPORATION, Seoul (KR)

(21) Appl. No.: 19/230,305

(22) Filed: Jun. 6, 2025

(30) Foreign Application Priority Data
Dec. 16, 2024 (KR) 10-2024-0187739

(51) Int. Cl. B60W 30/18; B60W 40/08; G01S 19/07

(52) U.S. Cl. CPC B60W 30/18163; B60W 40/08; G01S 19/07; B60W 2040/0881

(57) ABSTRACT

A vehicle control apparatus includes a communication device that receives driving information, location information, and passenger information of a vehicle. The vehicle control apparatus also includes a processor that determines whether it is possible for the vehicle to drive in a exclusive bus lane based on the received driving information, the received location information, and the received passenger information. The controls driving of the vehicle for the exclusive bus lane based on the received driving information, the received location information, and the received passenger information.

### CROSS-REFERENCE TO RELATED APPLICATION

This application claims the benefit of and priority to Korean Patent Application No. 10-2024-0187739, filed in the Korean Intellectual Property Office on Dec. 16, 2024, the entire contents of which are incorporated herein by reference.

### TECHNICAL FIELD

The present disclosure relates to a vehicle control apparatus and a vehicle control method. More particularly, the present disclosure relates to technologies for determining whether it is possible for a vehicle to drive in a exclusive bus lane and controlling driving of the vehicle based on the determined result.

### BACKGROUND

There is a exclusive bus lane on a highway. A van or a car with 9 seats to 12 seats and a bus may use the exclusive bus lane. Herein, the van or the car with 9 seats to 12 seats may drive in the exclusive bus lane, if 6 or more than 6 persons ride in the vehicle. For example, if 6 or more than 6 persons ride in a nine-seater car, the nine-seater car may drive in the exclusive bus lane on the highway. On the other hand, if 5 persons ride in the nine-seater car, the nine-seater car is unable to drive in the exclusive bus lane. If it is uncovered that the nine-seater car drives in the exclusive bus lane, the driver of the nine-seater car will be punished. Fines and penalty points may be imposed on cars and vans, upon the police crackdown. Upon detection by the enforcement camera, only fines may be imposed on cars and vans. The system related to such a exclusive bus lane was first introduced in 1970 and abolished in 2000 and is revived a year later and is still in effect.

However, there are increased cases in which some drivers abuse the exclusive bus lane by driving the van or the car in the exclusive bus lane, without considering the number of persons riding in the van or the car. Thus, there is a need for a technology for applying a function of preventing a vehicle capable of driving in the exclusive bus lane from violating the regulations for the exclusive bus lane, in an OEM stage of manufacturing vehicles. The subject matter described in this background section is intended to promote an understanding of the background of the disclosure and thus may include subject matter that is not already known to those of ordinary skill in the art. The statements in this section merely provide background information related to the present disclosure and may not constitute prior art.

### SUMMARY

The present disclosure has been made to solve the above-mentioned problems occurring in the prior art while advantages achieved by the prior art are maintained intact.

An aspect of the present disclosure provides a vehicle control apparatus and a vehicle control method for determining whether it is possible for a vehicle to drive in a exclusive bus lane and controlling driving of the vehicle based on the determined result.

Another aspect of the present disclosure provides a vehicle control apparatus and a vehicle control method for controlling a vehicle to drive in a exclusive bus lane based on precise positioning information of the vehicle.

The technical problems to be solved by the present disclosure are not limited to the aforementioned problems. Any other technical problems not mentioned herein should be clearly understood from the following description by those having ordinary skill in the art to which the present disclosure pertains.

According to an aspect of the present disclosure, a vehicle control apparatus of a vehicle may include a communication device that receives driving information, location information, and passenger information of the vehicle. The vehicle control apparatus may further include a storage configured to store the received driving information, the received location information, and the received passenger information. The vehicle control apparatus may further include a processor that determines whether it is possible for the vehicle to drive in a exclusive bus lane based on the received driving information, the received location information, and the received passenger information. The processor controls driving of the vehicle for the exclusive bus lane.

In an embodiment, the driving information may include at least one of navigation map information, accelerometer information, or gyro sensor information.

In an embodiment, the location information may include global navigation satellite system (GNSS) location coordinates. The processor may correct an error in the GNSS location coordinates to calculate precise positioning information of the vehicle.

In an embodiment, the processor may map the precise positioning information to the navigation map information to calculate lane location information of a lane in which the vehicle drives.

In an embodiment, the processor may determine whether there is the exclusive bus lane for the vehicle to drive, based on the lane location information.

In an embodiment, the processor may determine whether the number of passengers of the vehicle is greater than or equal to a predetermined number based on the passenger information and based on determining that there is the exclusive bus lane.

In an embodiment, the passenger information may include sitting sensor information and vehicle interior image information.

In an embodiment, the processor may control the vehicle to drive in the exclusive bus lane, based on determining that the number of the passengers is greater than or equal to the predetermined number.

In an embodiment, the processor may control the vehicle to avoid the exclusive bus lane, based on determining that the number of the passengers is less than the predetermined number.

In an embodiment, the processor may extract reference coordinates from the navigation map information; may match the reference coordinates with the GNSS location coordinates; and may determine whether the GNSS location coordinates are within an allowable error range.

In an embodiment, the processor may correct the GNSS location coordinates based on the accelerometer information and the gyro sensor information to calculate the precise positioning information, based on the GNSS location coordinates being out of the allowable error range.

According to another aspect of the present disclosure, a vehicle control method of a vehicle may include receiving driving information, location information, and passenger information of the vehicle. The vehicle control method may further include storing the received driving information, the received location information, and the received passenger information. The vehicle control method may further include determining whether it is possible for the vehicle to drive in a exclusive bus lane, based on the received driving information, the received location information, and the received passenger information. The vehicle control method may further include controlling driving of the vehicle for the exclusive bus lane based on the received driving information, the received location information, and the received passenger information.

In another embodiment, the driving information may include at least one of navigation map information, accelerometer information, or gyro sensor information.

In another embodiment, the location information may include global navigation satellite system (GNSS) location coordinates. Determining whether it is possible for the vehicle to drive in the exclusive bus lane may include correcting an error in the GNSS location coordinates to calculate precise positioning information of the vehicle.

In another embodiment, determining whether it is possible for the vehicle to drive in the exclusive bus lane may further include mapping the precise positioning information to the navigation map information to calculate lane location information of a lane in which the vehicle drives.

In another embodiment, determining whether it is possible for the vehicle to drive in the exclusive bus lane may further include determining whether there is the exclusive bus lane on a road for the vehicle to drive, based on the lane location information.

In another embodiment, the vehicle control method may further include determining whether the number of passengers of the vehicle is greater than or equal to a predetermined number based on the passenger information and based on determining that there is the exclusive bus lane.

In another embodiment, the passenger information may include sitting sensor information and vehicle interior image information.

In another embodiment, the vehicle control method may further include controlling the vehicle to drive in the exclusive bus lane, based on determining that the number of the passengers is greater than or equal to the predetermined number.

In another embodiment, the vehicle control method may further include controlling the vehicle to avoid the exclusive bus lane, based on determining that the number of the passengers is less than the predetermined number.

### BRIEF DESCRIPTION OF THE DRAWINGS

The above and other objects, features, and advantages of the present disclosure should be more apparent from the following detailed description taken in conjunction with the accompanying drawings:

FIG. 1 is a block diagram illustrating a configuration of a system including a vehicle control apparatus according to an embodiment of the present disclosure;

FIG. 2 is a block diagram illustrating a vehicle system including a vehicle control apparatus according to an embodiment of the present disclosure;

FIG. 3 is a drawing illustrating a type of a vehicle according to an embodiment of the present disclosure;

FIG. 4 is a drawing illustrating a vehicle, which drives in a exclusive bus lane, according to an embodiment of the present disclosure;

FIG. 5 is a flowchart for describing a vehicle control method according to an embodiment of the present disclosure;

FIG. 6 is a flowchart for describing in detail a vehicle control method according to an embodiment of the present disclosure;

FIG. 7 is a flowchart for describing in detail a vehicle control method according to an embodiment of the present disclosure;

FIG. 8 is a flowchart for describing in detail a vehicle control method according to another embodiment of the present disclosure;

FIG. 9 is a flowchart for describing in detail a vehicle control method according to another embodiment of the present disclosure; and

FIG. 10 is a block diagram illustrating a computing system according to an embodiment of the present disclosure.

### DETAILED DESCRIPTION

Hereinafter, some embodiments of the present disclosure should be described in detail with reference to the drawings. When the reference numerals to the components of each drawing are added, it should be noted that the identical or equivalent components are designated by the identical numerals even when the components are displayed on other drawings. Further, in describing the embodiment of the present disclosure, a detailed description of well-known features or functions has been omitted in order not to unnecessarily obscure the gist of the present disclosure.

In describing the components of the embodiment of the present disclosure, terms such as first, second, “A”, “B”, (a), (b), and the like may be used. These terms are only used to distinguish one component from another component and do not limit the corresponding components to the order or priority of the corresponding components. Furthermore, unless otherwise defined, all terms including technical and scientific terms used herein have the same meaning as being generally understood by those having ordinary skill in the art to which the present disclosure pertains. Such terms as those defined in a generally used dictionary should be interpreted as having meanings equal to the contextual meanings in the relevant field of art. The terms should not be interpreted as having ideal or excessively formal meanings unless clearly defined as having such in the present disclosure. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

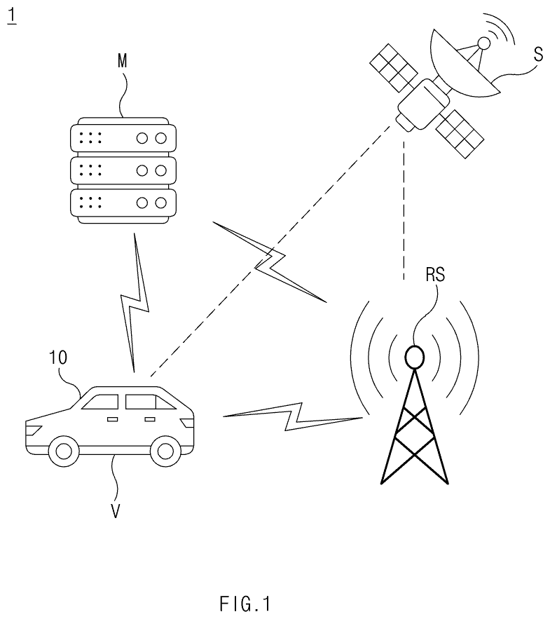

Hereinafter, embodiments of the present disclosure are described in detail with reference to FIGS. 1-10.

FIG. 1 is a block diagram illustrating a configuration of a system 1 including a vehicle control apparatus 10 according to an embodiment of the present disclosure.

Referring to FIG. 1, the system 1 may include a vehicle V, a global navigation satellite system (GNSS) satellite S, a reference station RS, and a map providing server M. Herein, the vehicle V may be an autonomous vehicle including an autonomous driving device. The autonomous vehicle refers to a device for controlling steering and a speed of the vehicle V based on information obtained via a plurality of vehicle sensors (e.g., a camera, radio detection and ranging (RADAR), light detection and ranging (LiDAR), and/or the like).

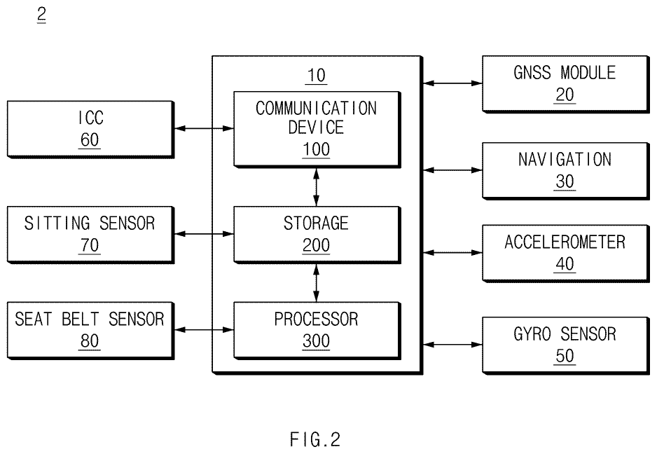

The vehicle control apparatus 10 according to an embodiment of the present disclosure may be implemented in the vehicle V. In this case, the vehicle control apparatus 10 of the vehicle V may be integrally configured with control units in the vehicle V or may be implemented as a separate device to be connected with the control units of the vehicle V by a separate connection means. The vehicle control apparatus 10 is described in detail below with reference to FIGS. 2-10.

Most navigation systems use a GNSS for accurately tracking a location of a target on the ground by using a plurality of global navigation satellite system (GNSS) satellites S. The GNSS is a system, which integrates various positioning systems using satellites, such as global positioning system (GPS) in the United States, global navigation satellite system (GLONASS) in Russian, European satellite navigation system (GALILEO) in Europe, BeiDou (Compass) in China, and the like.

Because the GNSS determines a location using a plurality of GNSS satellite S and a plurality of reference stations RS, it may easily obtain location, speed, and time information, regardless of a time and a space, and may be classified as a relatively stable system compared to the other navigation systems.

The vehicle V may include a GNSS receiver (or a GNSS module). The GNSS receiver may receive GNSS location signals from the plurality of GNSS satellites S and may calculate location information. Herein, the GNSS location signal may include distance information between the GNSS receiver and the plurality of GNSS satellites S. The location information calculated using the GNSS receiver may be represented as three-dimensional (3D) coordinates (x, y, z) composed of plane coordinates and a height. However, in the location information calculated alone by the GNSS receiver, an error may occur up to 15 m from a real location due to an error which occurs between GNSS observations. Thus, the vehicle control apparatus 10 of the vehicle V may correct the error in the above-mentioned location information.

The plurality of reference stations RS may be installed at certain reference points to receive GNSS location signals from the plurality of GNSS satellites S to generate GNSS correction information. Herein, the GNSS correction information is data for correcting an error in distance, which is caused by delay or failure of information reception from the GNSS satellite S, if the reference station RS located at the reference point communicates with the GNSS receiver of the vehicle V. In other words, the GNSS receiver of the vehicle V may receive the GNSS location signals from the plurality of GNSS satellites S and may receive GNSS correction information from the plurality of reference stations RS to generate location information. Thereafter, the vehicle control apparatus 10 of the vehicle V may correct the error in the generated location information to calculate precise positioning information. For example, the vehicle control apparatus 10 may accurately provide a lane location of a lane in which the vehicle V drives or the like, based on the precise positioning information. Herein, the precise positioning information may be to correct location information based on driving information. The precise positioning information may be a value obtained by measuring a location of the vehicle V to have a smaller error range than the location information. In other words, the precise positioning information may be a more precise positioning value of the vehicle than the location information received from the GNSS module.

The map providing server M may provide high-definition map data via navigation provided in the vehicle V. In other words, the high-definition map data may be included in navigation map information of the vehicle V. Herein, the high-definition map data may be data including all information necessary to control an autonomous driving operation of the vehicle V. The high-definition map data may include, but is not limited to, basic road information, surrounding environment information, detailed road environment information (e.g., a topographical elevation, a curvature, or the like), or dynamically changed road situation information (e.g., traffic congestion, an accident section, a construction section, or the like).

The high-definition map data may include SD+ high-definition map data. In other words, the high-definition map data may include map information for implementing a road and a surrounding environment in 3D within an error range with a very small size (e.g., for each centimeter (cm)). The high-definition map data may include environmental information around the road, which is implemented in 3D. The high-definition map data may include geometric information, such as a road shape (e.g., a road type, a road width, or a speed limit) or a facility structure. The high-definition map data may further include semantic information, such as a traffic signal and a lane mark. In other words, the high-definition map data may include road information, such as a exclusive bus lane.

The vehicle control apparatus 10 according to the present disclosure may accurately calculate a location of the vehicle V via the above-mentioned system 1 and may perform autonomous driving for the exclusive bus lane. Thus, the vehicle control apparatus 10 may improve reliability of the autonomous driving. In addition, the vehicle control apparatus 10 may prevent a driver of the vehicle V from violating regulations for the exclusive bus lane via the above-mentioned system 1.

FIG. 2 is a block diagram illustrating a vehicle system 2 including a vehicle control apparatus 10 according to an embodiment of the present disclosure.

Referring to FIG. 2, the vehicle system 2 may include the vehicle control apparatus 10, a GNSS module 20, navigation module 30, an accelerometer 40, a gyro sensor 50, an in-cabin camera (ICC) 60, a sitting sensor 70, and a seat belt sensor 80. The vehicle control apparatus 10 may include a communication device 100, a storage 200, and a processor 300.

The communication device 100 may receive driving information, location information, and passenger information of a vehicle.

The communication device 100 may perform controller area network (CAN) communication or wired communication. For example, a communication network including a body network, a multimedia network, a chassis network, and the like may be configured in a vehicle for control for various control systems loaded into the vehicle and communication between the various control systems. The respective networks separated from each other may be connected by the processor 300 to transmit and receive a controller area network (CAN) communication message therebetween. In other words, the communication device 100 may transmit various information to a vehicle system based on a control signal of the processor 300 and may receive various information from the vehicle system.

The storage 200 may store the received driving information, the received location information, and the received passenger information and may store all information performed by the processor 300.

The storage 200 may include at least one memory, which stores a program for performing the above-mentioned operation and an operation described below. Herein, the memory may include a read only memory (ROM) and a random access memory (RAM).

The processor 300 may determine whether it is possible for the vehicle to drive in a exclusive bus lane, based on the received driving information, the received location information, and the received passenger information. Herein, the driving information may include at least one of navigation map information, accelerometer information, or gyro sensor information. The location information may include GNSS location coordinates. The passenger information may include sitting sensor information and vehicle interior image information. Furthermore, the passenger information may include seat belt sensor information.

The processor 300 may control driving of the vehicle for the exclusive bus lane based on the above-mentioned information. For example, the processor 300 may control the vehicle to drive in the exclusive bus lane or may control the vehicle to avoid the exclusive bus lane.

In an embodiment, the processor 300 may correct an error in the GNSS location coordinates to calculate precise positioning information of the vehicle. For example, the processor 300 may extract reference coordinates from the navigation map information and may match the reference coordinates with the GNSS location coordinates. Next, the processor 300 may determine whether the GNSS location coordinates are within an allowable error range.

If the GNSS location coordinates are out of the allowable error range, the processor 300 may correct the GNSS location coordinates based on the accelerometer information and the gyro sensor information. Thus, the processor 300 may calculate precise positioning information. Thereafter, the processor 300 may map the precise positioning information to the navigation map information to calculate lane location information of a lane in which the vehicle drives. Herein, the lane location information may be information about a location of the lane in which the vehicle is currently driving. As described above, the processor 300 may accurately calculate the location of the vehicle to improve the reliability of the autonomous driving.

The processor 300 may determine whether there is a exclusive bus lane on the road on which the vehicle drives, based on the navigation map information and the lane location information.

If determining that there is the exclusive bus lane, the processor 300 may determine whether the number of passengers of the vehicle is greater than or equal to a predetermined number (e.g., 6) based on the passenger information. For example, the processor 300 may detect an object from the vehicle interior image to extract the number of passengers. Furthermore, the processor 300 may extract the number of passengers based on the sitting sensor information of a sitting sensor provided in a seat of the vehicle.

When determining that the number of the passengers of the vehicle is greater than or equal to the predetermined number (e.g., 6), the processor 300 may control the vehicle to drive in the exclusive bus lane. In other words, the processor 300 may transmit a driving control signal to a control unit of the vehicle, such that the vehicle drives in the exclusive bus lane, via the communication device 100. Thereafter, the processor 300 may check the precise positioning information and the lane location information in real time to determine whether the vehicle drives in the exclusive bus lane.

The predetermined number of passengers corresponding to the exclusive bus lane may be a value specified in advance by the road traffic laws and regulations of the applicable country or region.

On the other hand, when determining that the number of the passengers of the vehicle is less than the predetermined number (e.g.,6), the processor 300 may control the vehicle to avoid the exclusive bus lane. In other words, the processor 300 may transmit the driving control signal to the control unit of the vehicle, such that the vehicle drives in a general lane, via the communication device 100. Thereafter, the processor 300 may check the precise positioning information and the lane location information in real time to determine whether the vehicle drives in the general lane.

The processor 300 may include at least one processor for executing a program for performing the above-mentioned operation and an operation described below.

The storage 200 and the processor 300 may be integrated into one chip and may be physically separated from each other.

The GNSS module 20 may include a GNSS receiver. The GNSS receiver may obtain location information including GNSS location coordinates transmitted from a GNSS satellite and GNSS correction information transmitted from a reference station.

In an embodiment, the GNSS module 20 may transmit the location information to the processor 300 via the communication device 100.

The navigation 30 may receive high-definition map data and real-time traffic data from a map providing server M. Thus, the navigation 30 may provide a driver of the vehicle with a driving route and various information generated based on the high-definition map data. For example, a user may enter a destination via the navigation 30. The navigation 30 may deliver destination information entered from the user to a vehicle system. Thus, the vehicle may perform autonomous driving based on the destination information.

In an embodiment, the navigation 30 may transmit navigation map information, which is the high-definition map data, to the processor 300 via the communication device 100.

The accelerometer 40 refers to an acceleration sensor, which may measure acceleration and deceleration of the vehicle, which is driving. For example, the accelerometer 40 may include, but is not limited to, a mechanical acceleration sensor or a silicone acceleration sensor.

In an embodiment, the accelerometer 40 may transmit accelerometer information, which is driving information, to the processor 300 via the communication device 100. Thereafter, the processor 300 may calculate precise positioning information based on the accelerometer information.

The gyro sensor 50 refers to a gyroscope sensor, which may measure an azimuth incapable of being measured by the accelerometer. In other words, the gyro sensor 50 may sense an angular velocity, which is rotational motion of the vehicle.

If the gyro sensor 50 is unable to receive GNSS location signal, the gyro sensor 50 may estimate location information of the vehicle by using dead reckoning together with accelerometer information.

In an embodiment, the gyro sensor 50 may transmit gyro sensor information, which is driving information, to the processor 300 via the communication device 100. Thereafter, the processor 300 may calculate precise positioning information based on the gyro sensor information.

The ICC 60 may capture an image capture area facing the inside of the vehicle and may obtain vehicle interior image information, which is an image in the vehicle.

In an embodiment, the ICC 60 may transmit the vehicle interior image information to the processor 300 via the communication device 100. Thereafter, the processor 300 may extract passenger information based on the vehicle interior image information.

The sitting sensor 70 may refer to all sensors capable of sensing a state in which a passenger sits in the driver's seat, the passenger seat, and/or the rear seat. For example, the sitting sensor 70 may include, but is not limited to, a pressure sensor or a weight sensor, which is provided in the driver's seat, the passenger seat, and/or the rear seat.

In an embodiment, the sitting sensor 70 may transmit sitting sensor information to the processor 300 via the communication device 100. Thereafter, the processor 300 may extract passenger information based on the sitting information.

The seat belt sensor 80 may obtain information about whether the user wears the seat belt. The seat belt sensor 80 may refer to all types of sensors capable of sensing whether the user couples the seat belt to the buckle.

In an embodiment, the seat belt sensor 80 may transmit seat belt sensor information to the processor 300 via the communication device 100. Thereafter, the processor 300 may extract passenger information based on the seat belt sensor information.

As described above, the vehicle control apparatus 10 according to the present disclosure may control the autonomous driving of the vehicle with regard to the exclusive bus lane to improve the reliability of the autonomous driving. Furthermore, the vehicle control apparatus 10 may prevent the driver of the vehicle from violating regulations for the exclusive bus lane.

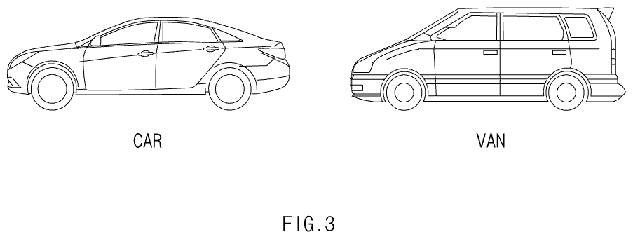

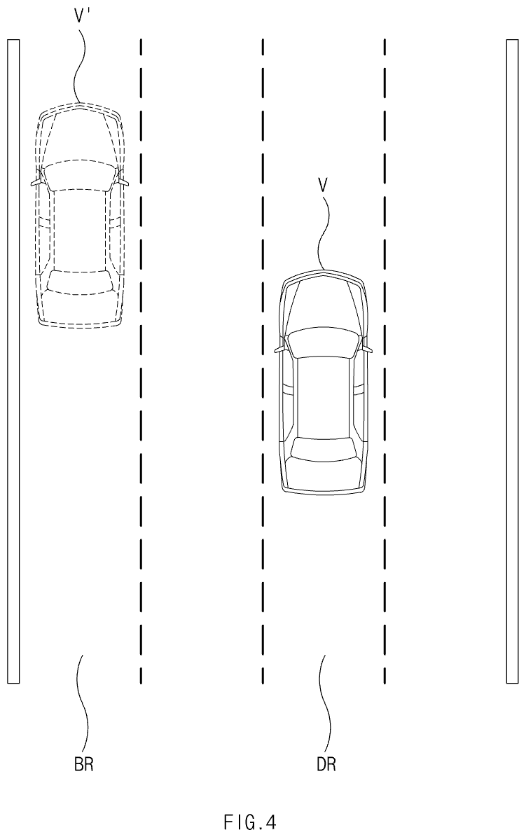

FIG. 3 is a drawing illustrating a type of a vehicle according to an embodiment of the present disclosure. FIG. 4 is a drawing illustrating a vehicle, which drives in a exclusive bus lane according to an embodiment of the present disclosure.

Referring to FIG. 3, a vehicle may be roughly divided into a car and a van. The car may include a sedan and a sports utility vehicle (SUV). In Korea, the riding capacity of the car is less than or equal to 10 persons and the riding capacity of the van is greater than or equal to 11 persons, according to regulations.

Furthermore, the van and even a car, the riding capacity of which is greater than or equal to 9 persons, may use the exclusive lane according to the regulations. However, the car having the riding capacity of greater than or equal to 9 persons and the van having the riding capacity of 11 persons may use a exclusive bus lane BR, only if the number of persons who are actually riding in the vehicle is greater than or equal to a predetermined number (e.g., 6).

In other words, the car or the van with 9 seats to 12 seats may use the exclusive bus lane BR, when 6 or more than a predetermined number (e.g.,6) ride in the car or van.

Referring to FIG. 4, it is assumed that a vehicle V is driving in a general lane DR rather than the exclusive bus lane BR. Herein, the vehicle V may include a car having the riding capacity of greater than or equal to 9 persons, and a van having the riding capacity of 11 persons.

A processor 300 of a vehicle control apparatus 10 according to the present disclosure may control driving of the vehicle V based on the above-mentioned exclusive bus lane regulations. For example, the processor 300 may determine whether passengers of the vehicle V are greater than or equal to a predetermined number (e.g., 6) based on passenger information. When determining that the number of the passengers of the vehicle V is greater than or equal to the predetermined number (e.g.,6) (such a vehicle is referred to as “V′”), as shown in FIG. 4, the processor 300 may control the vehicle V′ to drive in the exclusive bus lane BR. The processor 300 may transmit a driving control signal to the control unit of the vehicle V′, such that the vehicle V′ drives in the exclusive bus lane BR, via a communication device 100.

On the other hand, when determining that the passengers of the vehicle V is less than the predetermined number (e.g., 6), the processor 300 may control the vehicle V to avoid the exclusive bus lane BR. In other words, the processor 300 may transmit the driving control signal to the control unit of the vehicle V, such that the vehicle V drives in the general lane DR, via the communication device 100.

As described above, the vehicle control apparatus 10 according to the present disclosure may control the autonomous driving of the vehicle with regard to the exclusive bus lane to improve the reliability of the autonomous driving. Furthermore, the vehicle control apparatus 10 may prevent the driver of the vehicle from violating the regulations for the exclusive bus lane.

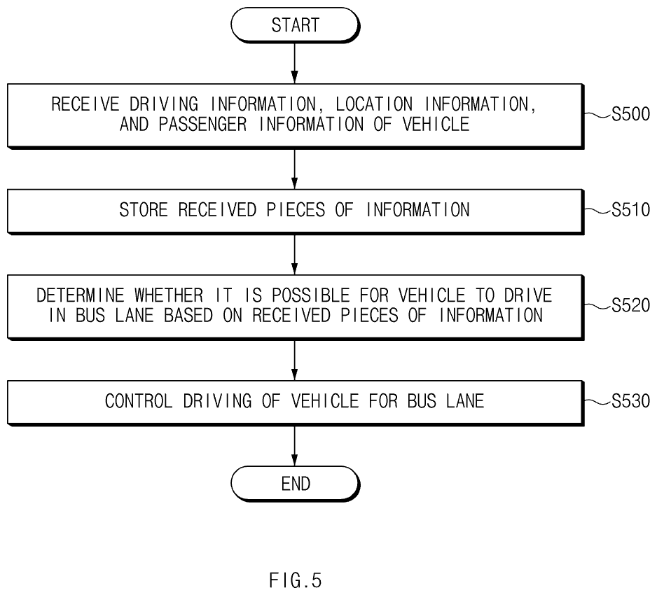

Hereinafter, a description is given in detail of a vehicle control method according to an embodiment of the present disclosure with reference to FIGS. 5-9.

Hereinafter, it is assumed that a vehicle control apparatus 10 of FIG. 2 performs processes of FIGS. 5-9. Furthermore, in descriptions of FIGS. 5-9, it may be understood that an operation described as being performed by an apparatus is controlled by a processor 300 of the vehicle control apparatus 10.

FIG. 5 is a flowchart for describing a vehicle control method according to an embodiment of the present disclosure.

Referring to FIG. 5, in S500, driving information, location information, and passenger information of a vehicle may be received. For example, a communication device 100 of FIG. 2 may receive the driving information, the location information, and the passenger information of the vehicle.

The communication device 100 may perform controller area network (CAN) communication or wired communication. In other words, the communication device 100 may transmit various information to a vehicle system based on a control signal of a processor 300 and may receive various information from the vehicle system.

Herein, the driving information may include at least one of navigation map information, accelerometer information, or gyro sensor information. The location information may include GNSS location coordinates. The passenger information may include sitting sensor information and vehicle interior image information. Furthermore, the passenger information may include seat belt sensor information.

In step S510, the received information may be stored. For example, the storage 200 of FIG. 2 may store the received driving information, the received location information, and the received passenger information and may store all information performed by the processor 300.

The storage 200 may include at least one memory which stores a program for performing the above-mentioned operation and an operation described below. Herein, the memory may include a read only memory (ROM) and a random access memory (RAM).

In operation S520, it may be determined whether it is possible for the vehicle to drive in a exclusive bus lane based on the received information. For example, the processor 300 of FIG. 2 may determine whether it is possible for the vehicle to drive in the exclusive bus lane, based on the received driving information, the received location information, and the received passenger information.

In S530, the driving of the vehicle for the exclusive bus lane may be controlled. For example, the processor 300 may control the driving of the vehicle for the exclusive bus lane. For example, the processor 300 may control the vehicle to drive in the exclusive bus lane or may control the vehicle to avoid the exclusive bus lane.

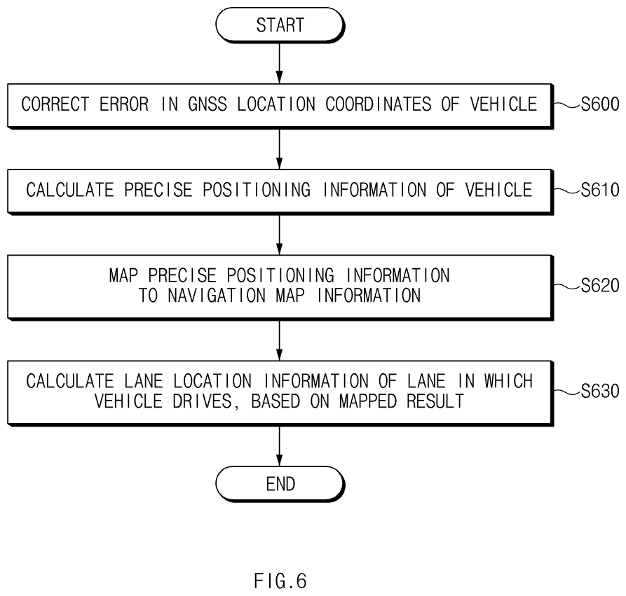

FIG. 6 is a flowchart for describing in detail a vehicle control method according to an embodiment of the present disclosure.

Referring to FIG. 6, in S600, an error in GNSS location coordinates of a vehicle may be corrected. For example, if the GNSS location coordinates are out of an allowable error range, a processor 300 may correct an error in location information based on driving information.

A GNSS receiver of the vehicle may receive GNSS location signals from a plurality of GNSS satellites and may receive GNSS correction information from a plurality of reference stations to generate location information. Herein, the location information may include GNSS correction information, as well as 3D GNSS location coordinates (x, y, z). The processor 300 may extract reference coordinates from navigation map information and may match the reference coordinates with the GNSS location coordinates. Next, the processor 300 may determine whether the GNSS location coordinates are within the allowable error range. When determining that the GNSS location coordinates are out of the allowable error range, the processor 300 may correct an error in location information to calculate precise positioning information.

In S610, precise positioning information of the vehicle may be calculated. For example, the processor 300 may calculate the precise positioning information of the vehicle. Herein, the precise positioning information may be used to correct location information based on driving information. The precise positioning information may be a value obtained by measuring a location of the vehicle to have a smaller error range than the location information. In other words, the precise positioning information may be a more precise positioning value of the vehicle than the location information received from the GNSS module.

In an embodiment, the processor 300 may combine location information, accelerometer information, and gyro sensor information to calculate the precise positioning information of the vehicle. Herein, the driving information may include the accelerometer information and the gyro sensor information. For example, an accelerometer may include a 3-axis acceleration sensor (accelerometer). A gyro sensor may include a 3-axis gyro sensor (angular velocity meter). The accelerometer may measure acceleration of the vehicle and the gyro sensor may measure an angular velocity of the vehicle.

The processor 300 may combine the angular velocity and the acceleration information of the vehicle to estimate a location of the vehicle. Thereafter, the processor 300 may measure a current location of the vehicle to have a smaller error range based on the estimated result and the received location information.

In S620, the precise positioning information may be mapped to navigation map information. For example, the processor 300 may map the precise positioning information to the navigation map information. Herein, the navigation map information may include high-definition map data. The high-definition map data may include basic road information, surrounding environment information, detailed road environment information (e.g., a topographical elevation, a curvature, or the like), or dynamically changed road situation information (e.g., traffic congestion, an accident section, a construction section, or the like). The high-definition map data may include SD+ high-definition map data. In other words, the high-definition map data may include map information for implementing a road and a surrounding environment in 3D within an error range with a very small size (e.g., for each centimeter (cm)). The high-definition map data may include environmental information around the road, which is implemented in 3D. The high-definition map data may further include geometric information, such as a road shape (e.g., a road type, a road width, or a speed limit) or a facility structure. The high-definition map data may further include semantic information, such as a traffic signal and a lane mark. In other words, the high-definition map data may include road information, such as a exclusive bus lane.

In S630, lane location information of a lane in which the vehicle drives may be calculated based on the mapped result. For example, the processor 300 may calculate the lane location information of the lane in which the vehicle drives, based on the mapped result. Herein, the lane location information may be information about a location of the lane in which the vehicle is currently driving. As described above, as the processor 300 maps the precise positioning information to the high-definition map data, it may calculate the precise lane location information with the small error range.

As described above, the vehicle control method according to the present disclosure may be used to accurately calculate the location of the vehicle to improve the reliability of the autonomous driving.

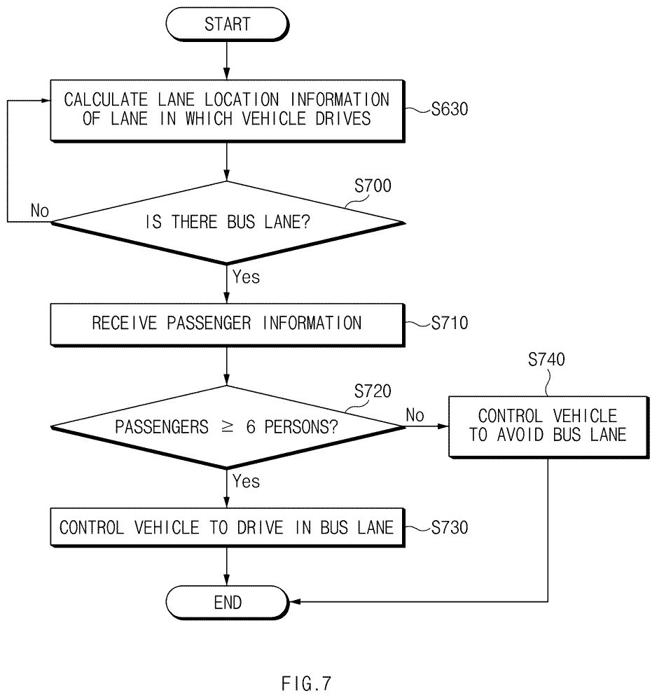

FIG. 7 is a flowchart for describing in detail a vehicle control method according to an embodiment of the present disclosure.

Referring to FIG. 7, in S630, lane location information of a lane in which a vehicle drives may be calculated. For example, a processor 300 may map precise positioning information to high-definition map data to calculate precise lane location information with a small error range.

In S700, it may be determined whether there is a exclusive bus lane. For example, the processor 300 may determine whether there is the exclusive bus lane on the road on which the vehicle drives, based on navigation map information and the lane location information.

If it is determined that there is no exclusive bus lane, in S630, lane location information of the lane in which the vehicle drives may be calculated again.

On the other hand, if it is determined that there is the exclusive bus lane (Yes in S700), in S710, passenger information may be received. For example, when determining that there is the exclusive bus lane, the processor 300 may receive the passenger information. Herein, the passenger information may include sitting sensor information and vehicle interior image information. Furthermore, the passenger information may include seat belt sensor information.

In S720, it may be determined whether the number of the passengers is greater than or equal to a predetermined number (e.g.,6). For example, the processor 300 may determine whether the number of the passengers of the vehicle is greater than or equal to the predetermined number (e.g., 6) based on the passenger information. The processor 300 may detect an object from the vehicle interior image to extract the number of passengers. Furthermore, the processor 300 may extract the number of passengers based on the sitting sensor information of a sitting sensor provided in a seat of the vehicle.

If it is determined that the number of the passengers is greater than or equal to the predetermined number (e.g., 6) (Yes in S720), in S730, the vehicle may be controlled to drive in the exclusive bus lane. For example, when determining that the number of the passengers of the vehicle is greater than or equal to the predetermined number (e.g., 6), the processor 300 may control the vehicle to drive in the exclusive bus lane. In other words, the processor 300 may transmit a driving control signal to a control unit of the vehicle, such that the vehicle drives in the exclusive bus lane, via a communication device 100. Thereafter, the processor 300 may check the precise positioning information and the lane location information in real time to determine whether the vehicle drives in the exclusive bus lane.

On the other hand, if it is determined that the number of the passengers is less than the predetermined number (e.g., 6) (No in S720), in S740, the vehicle may be controlled to avoid the exclusive bus lane. For example, when determining that the number of the passengers of the vehicle is less than the predetermined number (e.g., 6), the processor 300 may control the vehicle to avoid the exclusive bus lane. In other words, the processor 300 may transmit the driving control signal to the control unit of the vehicle, such that the vehicle drives in a general lane, via the communication device 100. Thereafter, the processor 300 may check the precise positioning information and the lane location information in real time to determine whether the vehicle drives in the general lane.

As described above, the vehicle control method according to the present disclosure may be used to control the autonomous driving of the vehicle with regard to the exclusive bus lane to improve the reliability of the autonomous driving.

Furthermore, the vehicle control method may be to prevent the driver of the vehicle from violating the regulations for the exclusive bus lane.

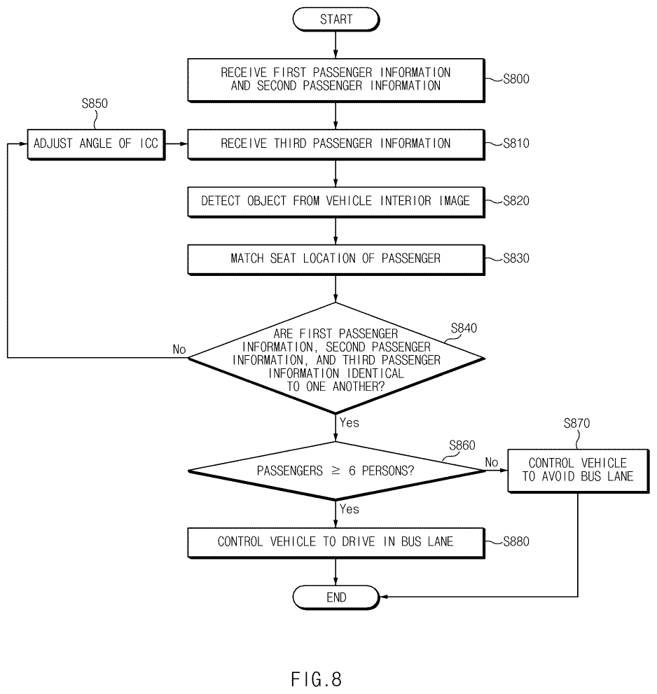

FIG. 8 is a flowchart for describing in detail a vehicle control method according to another embodiment of the present disclosure.

Referring to FIG. 8, in S800, first passenger information and second passenger information may be received. For example, a processor 300 may receive the first passenger information and the second passenger information. Herein, the first passenger information may be sitting sensor information and the second passenger information may be seat belt sensor information.

A sitting sensor may refer to all sensors capable of sensing a state in which a passenger sits in the driver's seat, the passenger seat, and/or the rear seat. For example, the sitting sensor may include, but is not limited to, a pressure sensor or a weight sensor, which is provided in the driver's seat, the passenger seat, and/or the rear seat.

A seat belt sensor may obtain information about whether a user wears a seat belt. The seat belt sensor may refer to all types of sensors capable of sensing whether the user couples the seat belt to the buckle.

In S810, third passenger information may be received. For example, the processor 300 may receive the third passenger information. Herein, the third passenger information may be vehicle interior image information. An ICC may capture an image capture area facing the inside of the vehicle and may obtain vehicle interior image information, which is an image in the vehicle.

In S820, an object may be detected from the vehicle interior image. For example, the processor 300 may detect the object from the vehicle interior image by using an object detection algorithm. Herein, the object may refer to a passenger.

For example, the vehicle interior image may be an RGB image for a face and an upper body of a passenger who sits in the driver's seat, the passenger seat, the rear seat, or the like. For another example, the vehicle interior image may be an image obtained from a heat image camera capable of obtaining temperature information of a subject. In other words, the vehicle interior image may be a thermal image for at least one of the driver's seat, the passenger seat, or the rear seat. At this time, the processor 300 may detect a passenger from the vehicle interior image using the object detection algorithm. The object detection algorithm may include a machine learning-based object detection algorithm. The processor 300 may perform feature extraction and feature classification based on the object detection algorithm.

In S830, a seat location of the passenger may be matched. For example, the processor 300 may match the seat location of the passenger based on the result of detecting the object. The processor 300 may determine whether the passenger is located in any one of the driver's seat, the passenger seat, or the rear seat based on the first passenger information, the second passenger information, and the third passenger information.

In S840, it may be determined that the first passenger information, the second passenger information, and the third passenger information are identical to one another. For example, the processor 300 may determine whether the first passenger information, the second passenger information, and the third passenger information are identical to one another.

If the first passenger information, the second passenger information, and the third passenger information are not identical to one another (No in S840), in S850, an angle of the ICC may be adjusted. For example, when determining that the first passenger information, the second passenger information, and the third passenger information are not identical to one another, the processor 300 may adjust the angle of the ICC. In other words, the processor 300 may output a signal for controlling the angle of the ICC. The ICC may perform a pan or tilt function based on the control signal.

The first passenger information may be sitting sensor information, and the second passenger information may be seat belt sensor information. An error in the first passenger information and the second passenger information may be a failure problem of a sitting sensor or a seat belt sensor. In this case, the error in the first passenger information and the second passenger information is unable to be resolved. On the other hand, the third passenger information may be vehicle interior image information obtained by the ICC. An error in the third passenger information may be a problem of an angle of the ICC as well as a failure in the ICC. For example, all passengers may fail to be captured due to the angle of the ICC. In this case, the processor 300 may adjust the angle of the ICC, such that the error in the third passenger information is able to be resolved.

If the first passenger information, the second passenger information, and the third passenger information are identical to one another (Yes in S840), in S860, it may be determined whether the number of the passengers is greater than or equal to a predetermined number (e.g., 6). For example, when determining that the first passenger information, the second passenger information, and the third passenger information are identical to one another, the processor 300 may determine whether the number of the passengers is greater than or equal to the predetermined number (e.g., 6).

If the number of the passengers is greater than or equal to the predetermined number (e.g., 6) (Yes in S860), in S880, the vehicle may be controlled to drive in the exclusive bus lane. when determining that the number of the passengers of the vehicle is greater than or equal to the predetermined number (e.g., 6), the processor 300 may control the vehicle to drive in the exclusive bus lane. In other words, the processor 300 may transmit a driving control signal to a control unit of the vehicle, such that the vehicle drives in the exclusive bus lane, via a communication device 100.

On the other hand, if the number of the passengers is less than the predetermined number (e.g., 6) (No in S860), in S870, the vehicle may be controlled to avoid the exclusive bus lane. For example, when determining that the number of the passengers of the vehicle is less than the predetermined number (e.g., 6), the processor 300 may control the vehicle to avoid the exclusive bus lane. In other words, the processor 300 may transmit the driving control signal to the control unit of the vehicle, such that the vehicle drives in a general lane, via the communication device 100.

As described above, the vehicle control method according to the present disclosure may compare the at least one piece of passenger information to improve the reliability of the autonomous driving for the exclusive bus lane.

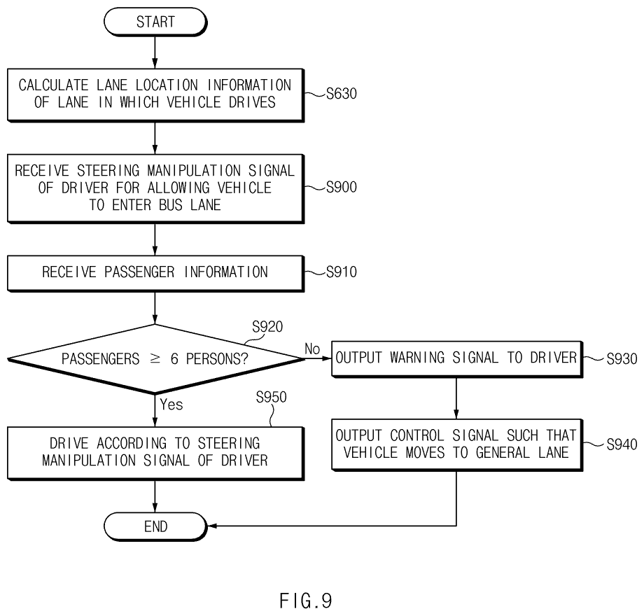

FIG. 9 is a flowchart for describing in detail a vehicle control method according to another embodiment of the present disclosure.

An autonomous driving control mode of a vehicle may include remote driving for allowing the vehicle to autonomously drive or allowing an operator outside the vehicle to perform remote manipulation (or external manipulation) such that the vehicle drives. Herein, the operator may not be a person and may be, for example, artificial intelligence (AI).

Meanwhile, a manual driving mode of the vehicle may mean that the driver rides in the vehicle to actually perform driving manipulation. The manual driving mode and the autonomous driving mode may switch by a control process of the vehicle.

Referring to FIG. 9, it is assumed that the vehicle operates in the manual driving mode.

In S630, lane location information of a lane in which the vehicle drives may be calculated. For example, a processor 300 may map precise positioning information to high-definition map data to calculate precise lane location information with a small error range.

In S900, a steering manipulation signal of a driver for allowing a vehicle to enter a exclusive bus lane may be received. For example, the processor 300 may receive the steering manipulation signal for allowing the vehicle to enter the exclusive bus lane. Because the vehicle operates in the manual driving mode, the driver may manipulate steering, and the steering manipulation signal may be transmitted to the processor 300.

In S910, passenger information may be received. For example, the processor 300 may receive the passenger information including sitting sensor information and vehicle interior image information.

In S920, it may be determined whether the number of passengers is greater than or equal to predetermined number (e.g., 6). For example, the processor 300 may determine whether the number of the passengers is greater than or equal to the predetermined number (e.g., 6) based on the sitting sensor information and the vehicle interior image information.

If the number of the passengers is less than the predetermined number (e.g., 6) (No in S920), in S930, a warning signal may be output to the driver. For example, when determining that the number of the passengers is less than the predetermined number (e.g., 6), the processor 300 may output the warning signal to the driver. Herein, the warning signal may include a visual signal, a tactile signal, and an audible signal. The processor 300 may provide the driver with the message “avoid the exclusive bus lane”. Alternatively, the processor 300 may provide the driver with the notification of “operating the autonomous driving control mode to avoid the exclusive bus lane”.

In S940, a control signal may be output such that the vehicle moves to a general lane. For example, the processor 300 may output the control signal such that the vehicle moves to the general lane. Thus, the vehicle may operate in the autonomous driving control mode and may move to the general lane. In other words, the vehicle may ignore a steering manipulation signal of the driver and may drive in the general lane.

On the other hand, if the number of the passengers is greater than or equal to the predetermined number (e.g., 6) (Yes in S920), in S950, the vehicle may drive according to the steering manipulation signal of the driver. For example, if the processor 300 determines that the number of the passengers is greater than or equal to the predetermined number (e.g., 6), the vehicle may drive according to the steering manipulation signal of the driver.

As described above, the vehicle control method according to the present disclosure may prevent the driver from violating the regulations for the exclusive bus lane, although the vehicle operates in the manual driving mode.

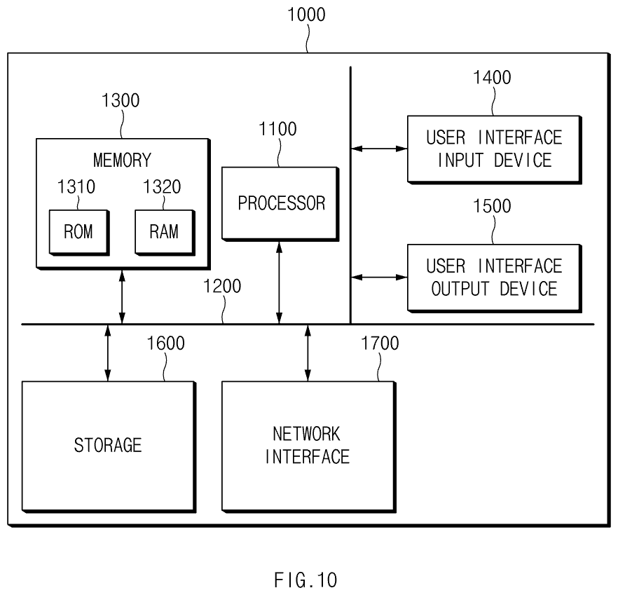

FIG. 10 illustrates a computing system according to an embodiment of the present disclosure.

Referring to FIG. 10, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or the algorithm described in connection with the embodiments disclosed in the present disclosure may be directly implemented with a hardware module, a software module, or a combination of the hardware module and the software module, which is executed by the processor 1100. The software module may reside on a storage medium (i.e., the memory 1300 and/or the storage module 1600), such as a RAM, a flash memory, a ROM, an EPROM, an EEPROM, a register, a hard disc, a removable disk, and a CD-ROM.

The storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The user interface input device 1400 may include an input device that receive a user input.

For example, the input device may receive various user inputs for setting a function of a vehicle from a user. For example, the input device may be provided as a tact switch, a joystick, a push switch, a slide switch, a toggle switch, a micro switch, or a touch screen. Furthermore, the input device may include a microphone for receiving a voice input of the user.

The user interface output device 1500 may include a display for displaying various information associated with driving of the vehicle and/or a function of the vehicle and a speaker for outputting various sounds associated with the driving of the vehicle and/or the function of the vehicle.

Herein, the display provides a user interface for allowing a passenger and the vehicle to interact with each other. For example, the display may include a liquid crystal display (LCD) panel and/or a light emitting diode (LED).

The display may provide the user with various information based on a control signal of the processor 1100. For example, the display may be provided in a center fascia, which is a central area of a dashboard in the vehicle. The display may be a component of a head unit and may be a component of a navigation device provided independently of the head unit. Herein, the head unit may process and output an audio signal and a video signal and may perform a navigation function. Thus, the head unit may be referred to as an audio video navigation (AVN) device.

For example, the display may display a route guidance screen, i.e., a screen necessary to perform the navigation function. Furthermore, the display may further display a screen necessary to perform an audio function, a video function, or a dialing function.

The speaker may output a sound necessary to perform the navigation function.

The network interface 1700 may include a long range communication module and/or a short range communication module, which transmit(s) and receive(s) data with an external device (e.g., a server or a user terminal). For example, the network interface 1700 may refer to a communication module capable of performing wireless Internet communication, such as a wireless LAN (WLAN), wireless broadband (Wibro), wireless-fidelity (Wi-Fi), world interoperability for microwave access (WiMAX), or high speed downlink packet access (HSDPA).

For example, the user may enter a destination via the user interface input device 1400 and the user interface output device 1500 may provide a route for reaching the destination.

The present technology may control autonomous driving of a vehicle with regard to a exclusive bus lane to improve reliability of the autonomous driving.

Furthermore, the present technology may prevent a driver of the vehicle from violating regulations for the exclusive bus lane.

Furthermore, the present technology may accurately calculate a location of the vehicle to improve reliability of autonomous driving.

In addition, various effects ascertained directly or indirectly through the present disclosure may be provided.

Hereinabove, although the present disclosure has been described with reference to embodiments and the accompanying drawings, the present disclosure is not limited thereto, but may be variously modified and altered by those having ordinary skill in the art to which the present disclosure pertains without departing from the spirit and scope of the present disclosure claimed in the following claims.

Therefore, embodiments of the present disclosure are not intended to limit the technical spirit of the present disclosure but provided only for the illustrative purpose. The scope of the present disclosure should be construed based on the accompanying claims, and all the technical ideas within the scope equivalent to the claims should be included in the scope of the present disclosure.

What is claimed is:

1. A vehicle control apparatus, comprising:
a communication device configured to receive driving information, location information, and passenger information of a vehicle;
a processor configured to:
determine whether it is possible for the vehicle to drive in a exclusive bus lane based on the received driving information, the received location information, and the received passenger information; and
control driving of the vehicle for the exclusive bus lane based on the received driving information, the received location information, and the received passenger information.

2. The vehicle control apparatus of claim 1, wherein the driving information includes at least one of navigation map information, accelerometer information, or gyro sensor information.

3. The vehicle control apparatus of claim 2, wherein the location information includes global navigation satellite system (GNSS) location coordinates, and
wherein the processor is configured to:
correct an error in the GNSS location coordinates to calculate precise positioning information of the vehicle.

4. The vehicle control apparatus of claim 3, wherein the processor is configured to:
map the precise positioning information to the navigation map information to calculate lane location information of a lane in which the vehicle drives.

5. The vehicle control apparatus of claim 4, wherein the processor is configured to:
determine whether there is the exclusive bus lane for the vehicle to drive, based on the lane location information.

6. The vehicle control apparatus of claim 5, wherein the processor is configured to:
determine whether the number of passengers of the vehicle is greater than or equal to a predetermined number based on the passenger information and based on determining that there is the exclusive bus lane.

7. The vehicle control apparatus of claim 6, wherein the passenger information includes sitting sensor information and vehicle interior image information.

8. The vehicle control apparatus of claim 7, wherein the processor is configured to:
control the vehicle to drive in the exclusive bus lane, based on determining that the number of the passengers is greater than or equal to the predetermined number.

9. The vehicle control apparatus of claim 7, wherein the processor is configured to:
control the vehicle to avoid the exclusive bus lane, based on determining that the number of the passengers is less than the predetermined number.

10. The vehicle control apparatus of claim 3, wherein the processor is configured to:
extract reference coordinates from the navigation map information;
match the reference coordinates with the GNSS location coordinates; and
determine whether the GNSS location coordinates are within an allowable error range.

11. The vehicle control apparatus of claim 10, wherein the processor is configured to:
correct the GNSS location coordinates based on the accelerometer information and the gyro sensor information to calculate the precise positioning information, based on the GNSS location coordinates being out of the allowable error range.

12. A vehicle control method of a vehicle, the vehicle control method comprising:
receiving driving information, location information, and passenger information of the vehicle;
determining whether it is possible for the vehicle to drive in a exclusive bus lane, based on the received driving information, the received location information, and the received passenger information; and
controlling driving of the vehicle for the exclusive bus lane based on the received driving information, the received location information, and the received passenger information.

13. The vehicle control method of claim 12, wherein the driving information includes at least one of navigation map information, accelerometer information, or gyro sensor information.

14. The vehicle control method of claim 13, wherein the location information includes global navigation satellite system (GNSS) location coordinates, and
wherein determining whether it is possible for the vehicle to drive in the exclusive bus lane includes:
correcting an error in the GNSS location coordinates to calculate precise positioning information of the vehicle.

15. The vehicle control method of claim 14, wherein determining whether it is possible for the vehicle to drive in the exclusive bus lane further includes:
mapping the precise positioning information to the navigation map information to calculate lane location information of a lane in which the vehicle drives.

16. The vehicle control method of claim 15, wherein determining whether it is possible for the vehicle to drive in the exclusive bus lane further includes:
determining whether there is the exclusive bus lane for the vehicle to drive, based on the lane location information.

17. The vehicle control method of claim 16, further comprising:
determining whether the number of passengers of the vehicle is greater than or equal to a predetermined number based on the passenger information and based on determining that there is the exclusive bus lane.

18. The vehicle control method of claim 17, wherein the passenger information includes sitting sensor information and vehicle interior image information.

19. The vehicle control method of claim 18, further comprising:
controlling the vehicle to drive in the exclusive bus lane, based on determining that the number of the passengers is greater than or equal to the predetermined number.

20. The vehicle control method of claim 18, further comprising:
controlling the vehicle to avoid the exclusive bus lane, based on determining that the number of the passengers is less than the predetermined number.
